(19) United States
(12) Patent Application Publication
(10) Pub. No.: US 2008/0152270 A1
(43) Pub. Date: Jun. 26, 2008

(54) Fluid dynamic bearing with axial preload

(76) Inventors: Martin Engesser, Donaueschingen (DE); Stefan Schwamberger, Hermsdorf (DE)

Correspondence Address: COOPER & DUNHAM, LLP, 1185 AVENUE OF THE AMERICAS, NEW YORK, NY, 10036, US

(21) Appl. No.: 12/001,834

(22) Filed: Dec. 13, 2007

(30) Foreign Application Priority Data
Dec. 22, 2006 (DE) 10 2006 062 206.5

(51) Int. Cl. F16C 17/10

(52) U.S. Cl. 384/107

(57) ABSTRACT

The invention relates to a fluid dynamic bearing system that comprises a bearing sleeve having a bearing bore and a shaft that is rotatably supported in the bearing bore by means of a fluid dynamic radial bearing. An annular first bearing plate connected to the shaft is provided that, together with a first end face of the bearing sleeve, forms a first fluid dynamic axial bearing, means of producing an axial counterforce to the first axial bearing being available. According to the invention, the axial counterforce is applied by means of a combination of a mechanical spring element and a second fluid dynamic axial bearing. Since the spring force of a preloaded spring does not change significantly over small distances, compensation for tolerances is made possible without the bearing system losing its axial stiffness or being subjected to too much stress.

### BACKGROUND OF THE INVENTION

The invention relates to a fluid dynamic bearing system having an axial preload, as used, for example, in bearings for electric motors. The bearing system comprises a bearing sleeve having a bearing bore and a shaft that is rotatably supported in the bearing bore by means of a fluid dynamic radial bearing. An annular first bearing plate connected to the shaft is provided which, together with an end face of the bearing sleeve, forms a first fluid dynamic axial bearing. Means of generating an axial counterforce (preload) to the first axial bearing are further provided.

### PRIOR ART

Due to the small bearing gaps (typically 10 μm) required nowadays, it is necessary to manufacture the parts of a modern fluid dynamic axial bearing with high precision. A fluid dynamic axial bearing comprises, for example, an upper and a lower bearing part and a bearing plate located between these two parts. These parts have to fit each other accurately within a matter of just a few μm. This is why increasing use is being made in electric motors of magnetically preloaded axial bearings, particularly when only one fluid dynamic axial bearing is formed between the end face of a bearing sleeve and a hub. In this design, a counterforce is applied to the single fluid dynamic axial bearing, not by a second fluid dynamic bearing, but rather by a magnetic preload in an axial direction. The magnetic preload can be produced by designing the electromagnetic drive system of the motor accordingly, in that the rotor magnet is axially offset vis-á-vis the stator arrangement. The height of the bearing sleeve is thus no longer critical for the function of the preload. Should a magnetic force be either too weak, not desirable (because of its unfavorable noise behavior) or not possible (applications other than electric motors), this design and construction cannot be used.

### SUMMARY OF THE INVENTION

It is thus the object of the invention to provide a fluid dynamic bearing in which an almost constant axial preload can be achieved using the simplest means possible.

This object has been achieved by the characteristics of the independent claim.

Preferred embodiments of the invention are cited in the subordinate claims.

The fluid dynamic bearing system according to the invention comprises a bearing sleeve having a bearing bore and a shaft that is rotatably supported in the bearing bore by means of a fluid dynamic radial bearing. An annular first bearing plate connected to the shaft is provided which, together with a first end face of the bearing sleeve, forms a first fluid dynamic axial bearing, means of producing an axial counterforce to the first axial bearing being provided.

The axial counterforce is applied according to the invention by the combination of a mechanical spring element and a second fluid dynamic axial bearing. The spring element may take the form of a spring washer or a Belleville spring washer.

Since the spring force of a preloaded spring does not change significantly over short distances, compensation for tolerances is made possible without the bearing system losing its axial stiffness or being subjected to too much stress.

In a first embodiment of the invention, the spring element is supported on one side at the shaft, or a part connected to the shaft, and on the other side at a second end face of the bearing sleeve. The spring element has an annular radial flange that is located opposite the second end face of the bearing sleeve, the second fluid dynamic axial bearing being formed by the mutually facing surfaces of the radial flange and the second end face of the bearing sleeve.

In another embodiment of the invention, the spring element is supported on one side at the shaft, or a part connected to the shaft, and on the other side at a second bearing plate abutting the second end face of the bearing sleeve. The spring element abuts against the second bearing plate, the fluid dynamic axial bearing being formed between the surfaces of the second bearing plate and the second end face of the bearing sleeve. The second bearing plate is fixedly connected to the shaft for correct operation and thus rotates with respect to the bearing sleeve.

In both embodiments of the invention, the spring element is fixedly connected to the shaft, whereas it rotates with respect to the bearing sleeve.

At least one of the mutually facing bearing surfaces of the second fluid dynamic bearing has a surface pattern that is at least partly filled with a bearing fluid. The surface pattern can, for example, take the form of a groove pattern. The groove pattern forms a pumping structure that, on rotation of the fluid dynamic axial bearing, ensures distribution of the bearing fluid in the bearing gap between the mutually facing bearing surfaces.

In addition to the surface pattern, a space, such as a circular groove, can be provided in the end face of the flange of the spring element or the end face of the second bearing plate, at the inside and/or the outside diameter of the relevant bearing surface. This space is at least partly filled with bearing fluid and forms a reservoir for the bearing fluid. The space is connected to the adjoining surface pattern, so that, on rotation of the bearing, any fluid held there can be conveyed into the grooved pattern.

It can be provided that the spring element and/or the second bearing plate simultaneously act as a seal in order to seal the bearing system, particularly the axial bearing, towards the outside.

As applies similarly to the second axial bearing, the bearing plate of the first radial bearing may also take the form of a flange of a spring element. This goes to produce a two-sided, preloaded axial bearing system.

Embodiments of the invention are described below on the basis of the drawings.

### BRIEF DESCRIPTION OF THE DRAWINGS

FIG. 1a shows a first embodiment of the fluid dynamic bearing system having an axial preload at one end.

FIG. 1b shows a variant of the first embodiment of the fluid dynamic bearing system having an axial preload at one end.

FIG. 2 shows a second embodiment of the fluid dynamic bearing system having an axial preload at one end.

FIG. 3 shows a third embodiment of the fluid dynamic bearing system having an axial preload at one end.

FIG. 4 shows a fourth embodiment of the fluid dynamic bearing system having an axial preload at both ends.

FIG. 5 shows an enlarged view of the region of the second axial bearing of FIG. 1.

FIG. 6 shows an enlarged view of the region of the second axial bearing of FIG. 2.

FIG. 7 shows an alternative view of a second bearing plate.

### DETAILED DESCRIPTION OF THE PREFERRED EMBODIMENTS OF THE INVENTION

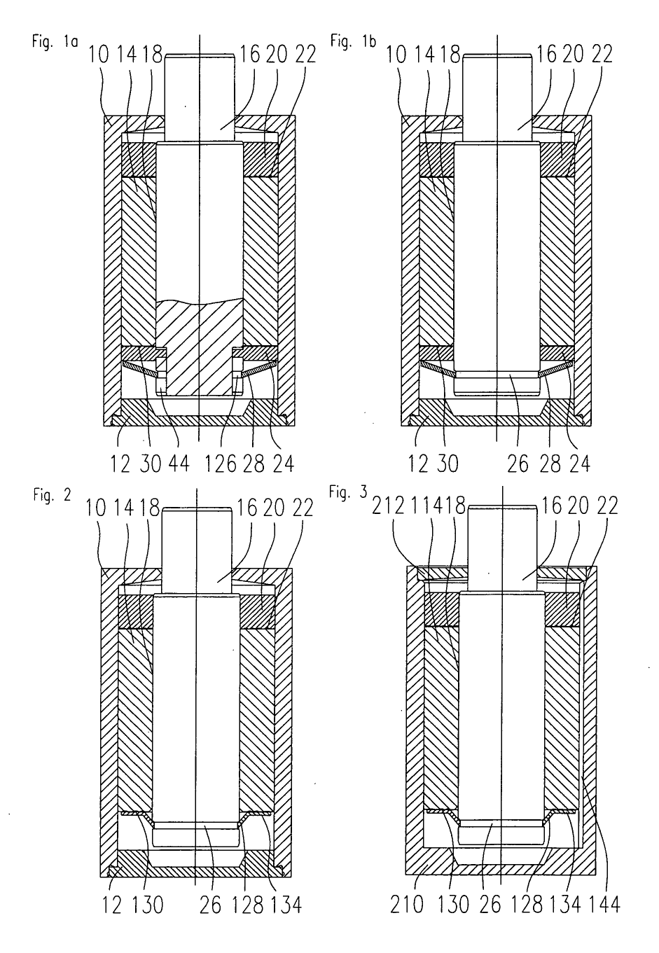

FIG. 1 shows a first embodiment of the fluid dynamic bearing system according to the invention. The bearing system is accommodated, for example, in a housing 10 that can be tightly sealed using a bottom cover 12. A bearing sleeve 14 having a central bore and fixedly connected to the housing 10 is disposed in the housing. A shaft 16 is inserted into the bore, the diameter of the shaft being slightly smaller than the diameter of the bore. A bearing gap 18 remains between the surfaces of the bearing sleeve 14 and the shaft 16, the bearing gap forming part of a fluid dynamic radial bearing by means of which the shaft is rotatably supported in the bore of the bearing sleeve. The bearing gap 18 is filled with a suitable bearing fluid. According to the invention, provision can also be made for the entire housing 10 to be filled with a bearing fluid and then sealed with the cover 12. A free end of the shaft 16 is led hermetically sealed out of the housing 10, thus ensuring as far as possible that no dirt penetrates into the bearing from the outside and no bearing fluid escapes.

An annular first bearing plate 20 is disposed at one end of the shaft 16, which, together with a first end face of the bearing sleeve 14, forms a first fluid dynamic axial bearing 22. For this purpose, one of the bearing surfaces is provided with a surface pattern that, on rotation of the shaft, exerts a fluid dynamic effect on the bearing fluid found between the bearing plate and the end face of the bearing sleeve, giving the axial bearing its load-carrying capacity.

A second, annular bearing plate 24 freely abuts the second end face of the bearing sleeve 14 and is axially held by the spring force of the spring element 28. The second bearing plate 24 is fixedly connected to the shaft by at least one recess in the shaft (16), the recess being greater in its axial extension than the thickness of the bearing plate 24 to allow movement in an axial direction. The bearing plate 24 is restricted in its axial movement by a ring 44 slid onto the shaft. The required axial preload or axial counterforce for the first axial bearing 22 is produced according to the invention by a spring element 28 that is supported on one side in a recess 126 in the ring 44 and on the other side at the second bearing plate 24. Mutually facing bearing surfaces of the second bearing plate 24 and the end face of the bearing sleeve 14 form a second fluid dynamic axial bearing, on which a preload generated by the spring element 28 is exerted accordingly. When the bearing system is at a standstill, the two bearing plates 20 and 24 abut against the respective end face of the bearing sleeve 14 and are braced against each other by the spring element 28.

FIG. 5 shows an enlarged view of the region of the second axial bearing 30. According to the invention, the mutually facing surfaces of the second bearing plate 24 and the end face of the bearing sleeve 14 form sliding surfaces of the second fluid dynamic axial bearing 30 whose effect only comes into being when the second bearing plate 24 rotates with respect to the bearing sleeve 14. The sliding surfaces are then separated from one another by a bearing gap. One of the two surfaces, the surface of the bearing sleeve 14 in the example, has a grooved pattern 40 that is at least partly filled with a bearing fluid. The grooved pattern 40 forms a pumping pattern using a conventional manner for the purpose of distributing the bearing fluid in the bearing gap between the mutually facing surfaces of the second fluid dynamic axial bearing 30. On rotation of the shaft 14, the spring element 28 and the second bearing plate 24 also rotate with respect to the bearing sleeve 14, the second bearing plate 24 lifting up off the end face of the bearing sleeve 14 due to the pumping effect on the bearing fluid and the fluid dynamic effect thus brought about.

Since the viscosity of the bearing fluid, preferably a liquid lubricant, depends on the temperature, the height by which the second bearing plate 24 lifts up off the end face of the bearing sleeve 14 can change. This change in height, however, amounts to only a few micrometers. Hence, it is only small compared to the overall spring travel of the spring element 28 and thus not significant for the magnitude of the preload of the axial bearing.

Air, oil or bearing grease may be used as the bearing fluid. Should a liquid bearing fluid be used, it is preferable if a supply of this bearing fluid is provided to last the useful life of the bearing. It is also possible to fill the bearing housing 10 fully with bearing fluid, so that sufficient bearing fluid is always available in the bearing regions. In this case, a largely encapsulated fluid dynamic bearing system is involved.

FIG. 1b substantially corresponds to FIG. 1a, identical parts being indicated by the same reference numbers. In contrast to FIG. 1a, the spring 28 is fixedly connected to the shaft in a recess 26 provided in the shaft and the bearing plate 24 is fixed to the spring 28, such that axial movement of the bearing plate 24 is still made possible.

FIG. 2 shows a second embodiment of the invention whose main parts correspond to the embodiment according to FIG. 1b. Identical parts are therefore indicated by the same reference numbers.

In contrast to FIG. 1b, in FIG. 2 the second axial bearing 130 is formed directly by the end face of the bearing sleeve 14 and a flange 134 of the spring element 128 adjoining the end face. Thus a second bearing plate is no longer provided, but rather the flange 134 of the spring element 128 assumes the function of the second bearing plate.

FIG. 6 shows an enlarged view of the region of the second axial bearing 130. The end face of the bearing sleeve 14 is preferably provided with a surface pattern 140 taking the form of a groove pattern. If the bearing arrangement does not swim in bearing fluid, free space 138 has to be further provided in the bearing sleeve 14, the free space being partly filled with bearing fluid and acting as a reservoir. This free space 138 is connected to the surface pattern 140. The flange 134 of the spring element 128 is disposed opposite the end face of the bearing sleeve 14. On rotation of the spring element 128 with respect to the bearing sleeve 14, fluid dynamic pressure is built up within the bearing fluid that is found in the spaces and the surface pattern, so that the flange 134 of the spring element 128 is lifted up off the end face of the bearing sleeve 14 and the two parts are separated from one another by a bearing gap.

FIG. 3 shows a modified embodiment of the arrangement according to FIG. 2. In contrast to FIG. 2, in FIG. 3 the housing 210 is closed at its lower region and sealed by a cover 212 at its upper region. The cover has an opening through which the free end of the shaft 16 is led. In addition, there is a recirculation channel 144 that may be formed by at least one channel in the bearing sleeve 114 or in the housing 210 and makes possible a recirculation of the bearing fluid between the axial bearing regions. Otherwise the embodiments according to FIG. 2 and FIG. 3 are identical, identical parts being provided with the same reference numbers.

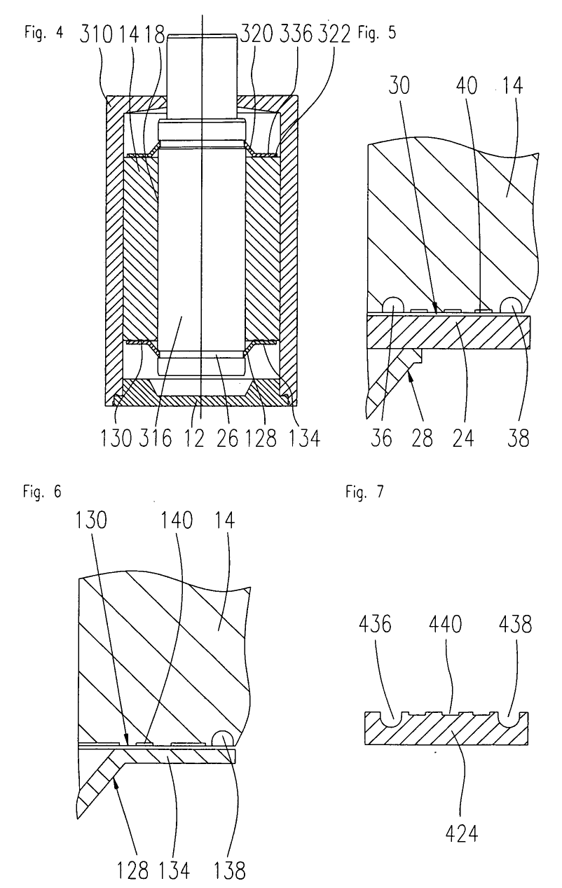

FIG. 4 shows an embodiment of the invention having two preloaded axial bearings. The bearing system is disposed in a housing 310 that is closed by a bottom cover 312. A first axial bearing 322 is provided that is formed by a first end face of the bearing sleeve 14 and a first spring element 320, whose radial flange 336 lies opposite the end face of the bearing sleeve 14 and forms a fluid dynamic axial bearing with this end face.

At the opposite end of the bearing sleeve 15, a second axial bearing 130 is provided that is formed by the other end face of the bearing sleeve 14 and a radial flange 134 of a second spring element 128. The entire bearing housing 310 is preferably filled with bearing fluid, so that both the bearing gap 18 of the radial bearing as well as the two axial bearings 322 and 130 have sufficient bearing fluid available.

FIGS. 5 and 6 show embodiments in which at least one fluid reservoir is provided in the region of the outside diameter of the bearing sleeve 14. The fluid reservoir is formed as a space or as a groove 36, 38 or 138 respectively that is formed in the end face of the bearing sleeve 14. The fluid dynamic surface patterns 40 or 140 respectively engage in this space 36, 38 or 138 respectively and carry fluid into the actual bearing patterns. This process ends when a balance is achieved between the forces that pump inwards (i.e. out of the fluid reservoir) and the forces that are effective towards the outside. Particularly when there is the risk of bearing fluid leaving the fluid dynamic axial bearing region, which could be brought about, for example, by manufacturing tolerances or by the fluid being pressed out during transition from rotation to standstill, two fluid reservoirs 36, 38 can then be used as shown in FIG. 5. These can then be disposed on each side of the fluid dynamic surface patterns 40. The surface patterns 40 engage in both reservoirs and ensure a constant supply of bearing fluid.

As can be seen from FIG. 7, provision can also be made for the surface patterns 440 and spaces 436, 438 to be formed in the second bearing plate 424 and not in the bearing sleeve. Bearing plate 424 can then be used, for example, in the place of bearing plate 24 of the second axial bearing 30 according to FIGS. 1 and 5

### IDENTIFICATION REFERENCE LIST

10 Housing
12 Cover
14 Bearing sleeve
16 Shaft
18 Bearing gap
20 Bearing plate (first)
22 Axial bearing (first)
24 Bearing plate (second
26 Recess (shaft)
28 Spring element
30 Axial bearing (second)
36 Space
38 Space
40 Surface pattern
42 Radial bearing
44 Ring
126 Recess (ring)
128 Spring element
130 Axial bearing (second)
134 Flange
138 Space
140 Surface pattern
144 Recirculation channel
210 Housing
212 Cover
310 Housing
312 Cover
316 Shaft
320 Spring element
322 Axial bearing (first)
336 Flange
424 Bearing plate (second)
436 Space
438 Space
440 Surface pattern

1. A fluid dynamic bearing system comprising:
a bearing sleeve (14) having a bearing bore,
a shaft (16; 316) that is rotatably supported in the bearing bore by means of a fluid dynamic radial bearing,
an annular first bearing plate (20; 320) connected to the shaft (16; 316) that, together with a first end face of the bearing sleeve (14), forms a first fluid dynamic axial bearing (22; 322),
and means of producing an axial counterforce to the first axial bearing,
characterized in that
the means of producing the axial counterforce consist of a combination of a mechanical spring element (28; 128) and a second fluid dynamic axial bearing (30; 130).

2. A fluid dynamic bearing system according to claim 1, characterized in that the spring element (28; 128) is a spring washer or a Belleville spring washer.

3. A fluid dynamic bearing system according to claim 1, characterized in that the spring element (28; 128) is supported on one side at the shaft (16; 316), or a part connected to the shaft, and on the other side at a second end face of the bearing sleeve (14).

4. A fluid dynamic bearing system according to claim 1, characterized in that the spring element (128) has an annular radial flange (134) that lies opposite a second end face of the bearing sleeve (14), a second fluid dynamic axial bearing (130) being formed by opposing bearing surfaces of the radial flange (134) and the second end face of the bearing sleeve (14).

5. A fluid dynamic bearing system according to claim 1, characterized in that the spring element (28) is supported on one side at the shaft (16), or a part connected to the shaft, and on the other side at a second bearing plate (24; 424) abutting a second end face of the bearing sleeve (14).

6. A fluid dynamic bearing system according to claim 5, characterized in that the spring element (28) abuts against the second bearing plate (24; 424), the fluid dynamic axial bearing (30) being formed by opposing bearing surfaces of the second bearing plate (24; 424) and the second end face of the bearing sleeve (14).

7. A fluid dynamic bearing system according to claim 5, characterized in that the bearing surfaces of the second fluid dynamic axial bearing (30; 130) are formed by the surfaces of the flange (134) of the spring element (128) or the second bearing plate (24; 424) respectively and the second end face of the bearing sleeve (14).

8. A fluid dynamic bearing system according to claim 1, characterized in that one of the mutually facing bearing surfaces of the second fluid dynamic axial bearing (30; 130) has a surface pattern (40; 140; 440) that is at least partly filled with a bearing fluid.

9. A fluid dynamic bearing system according to claim 8, characterized in that the surface pattern (40; 140; 440) is a pumping pattern for the distribution of bearing fluid between the mutually facing bearing surfaces of the second axial bearing (30; 130).

10. A fluid dynamic bearing system according to claim 1, characterized in that at least one annular space (436; 438) is provided in the end face of a second bearing plate (24; 424) at the inside and/or the outside diameter of the bearing surface, of which at least one space is at least partly filled with bearing fluid and forms a reservoir for a bearing fluid.

11. A fluid dynamic bearing system according to claim 1, characterized in that at least one annular space (36; 38; 138) is provided in a second end face of the bearing sleeve (14) at the inside and/or the outside diameter of the bearing surface, of which at least one space is at least partly filled with bearing fluid and forms a reservoir for a bearing fluid.

12. A fluid dynamic bearing system according to claim 11, characterized in that the space (36; 38; 138; 436; 438) is connected to an adjoining surface pattern (40; 140; 440).

13. A fluid dynamic bearing system according to claim 11, characterized in that the spring element (128) or a second bearing plate (24; 424) form a sealing arrangement for the axial bearing.

14. A fluid dynamic bearing system according to claim 1, characterized in that the first bearing plate is formed as a further spring element (320) and has a radial flange (336) that, together with the first end face of the bearing sleeve (14), forms the first axial bearing (322).

15. A fluid dynamic bearing system according to claim 1, characterized in that the first bearing plate (20) is preloaded by a further spring element and the first bearing plate (20), together with the first end face of the bearing sleeve (14), forms the first axial bearing (22).
